(19) United States
(12) Patent Application Publication
(10) Pub. No.: US 2009/0068338 A1
(43) Pub. Date: Mar. 12, 2009

(54) ROASTING DEVICE FOR VEGETABLE BULK MATERIAL AND METHOD FOR OPERATING A ROASTING DEVICE FOR VEGETABLE BULK MATERIAL

(76) Inventors: Stephan Lange, Kleve (DE); Gerhard A. Jansen, S'Heerenberg (NL); Uwe Moeller-Willenberg, Kleve (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/658,428

(22) PCT Filed: Aug. 5, 2005
(86) PCT No.: PCT/EP2005/053873

§ 371 Date: Nov. 18, 2008

(30) Foreign Application Priority Data
Aug. 10, 2004 (DE) 10 2004 038 730.3

(51) Int. Cl. A23F 5/04; A47J 37/06

(52) U.S. Cl. 426/629; 99/357

(57) ABSTRACT

A roasting device for vegetable bulk material, in particular coffee beans, comprises a roasting container for roasting said vegetable bulk material. The roasting container has connected therewith a gas heating furnace for supplying heated gases to the roasting container. Further, the roasting device comprises an exhaust gas purifier connected via a gas line with the roasting container. For purifying the exhaust gas, the exhaust gas purifier comprises an oxidation bed made up of porous heat-accumulating and heat-exchanging material. Further, a heating element for heating a middle region of the oxidation bed to an oxidation and/or self-decomposition temperature, and a flow reverser for reversing the direction of flow through the oxidation bed are provided in the exhaust gas purifier.

### BACKGROUND

1. Field of the Disclosure

The present disclosure relates to a roasting device for vegetable bulk material, in particular coffee beans. Further, the present disclosure relates to a method for operating a roasting device for vegetable bulk material, in particular coffee beans.

2. Discussion of the Background Art

When vegetable products are roasted, the organic roasting losses produce odorous substances and gaseous organic airborne pollutants. When coffee beans are roasted, essentially substances of the following substance classes are produced, for example: aldehydes, alcohols, amines, phenols, carbon acids, esters, ketones, mercaptans, and carbon monoxide. The roasting exhaust gases must be purified and liberated from product-specific odorous substances with the aid of a suitable exhaust gas purification process before they are allowed to be discharged to the atmosphere. The statutory emission limit values must be complied with. For Germany, the Administrative Regulation “TA Luft” [technical instruction on air pollution control] of the Federal Emission Protection Law stipulates the emission requirements; i.e. the concentrations in the exhaust air may reach the following values:

max. 50 mg/m³ C_{Ges},

max. 100 mg/m³ CO,

max. 20 mg/m³ formaldehyde,

max. 100 mg/m³ acetic acid

max. 350 mg/m³ SO₂,

less than 350 mg/m³ NOx.

A special characteristic of the coffee roasting process is that during the roasting reaction considerable amounts of nitrogen compounds are produced by the coffee beans, which nitrogen compounds concentrate in the roasting exhaust air. During the catalytic exhaust gas combustion, large portions of the nitrogen compounds oxidize to form NOx. Here, the higher the carbon compound concentration to be oxidized, the more NOx is produced in the purified exhaust gas.

For oxidizing the pollutants in the roasting exhaust air such that they form CO₂ and H₂O, and for removing product-specific odorous substances from the exhaust air, essentially two prior art methods are known and applied in conventional industrial plants (cf. VDI Directive VDI 3892 of February 2003):
I. Thermal roasting exhaust gas combustion:
In this process, the roasting exhaust gas flow is heated to more than approximately 800° C. with the back-up flame of a fan burner. An adequate turbulence and dwell time of the roasting exhaust gases in the hot reaction region must be ensured (cf. EP 0 862 370 B1). The method is expensive since a large amount of energy is required for heating the roasting exhaust gas flow. Even if heat exchangers are additionally installed for recovery of the exhaust gas heat, only limited rates of utilization of approximately 70% can be realized.
II. Catalytic roasting exhaust gas combustion:
Catalysts allow a combustion process to be carried out at comparably low temperatures. The process is however strongly susceptible to temperature changes. In most cases, controlled preheating means with fan burner are required for increasing the temperature of the roasting exhaust gases prior to their entering into the catalyst. The catalytically active layers are sensitive to an increasing pollutant concentration. They are not capable of treating excessive concentrations of combustible substances and must be protected against destruction due to excessive reaction temperatures. Even in normal operation, the catalytically active layers loose their efficiency over time. Since the catalysts are precious-metal catalysts, each replacement is expensive.

It is an object of the present disclosure to provide a roasting device for roasting vegetable bulk material, in particular coffee beans, wherein an emission reduction can be attained, and at the same time a high rate of heat utilization can be achieved. It is another object is to provide a corresponding method for operating a roasting device.

### SUMMARY OF THE DISCLOSURE

The present disclosure relates to a method and a device for roasting vegetable bulk material, wherein the exhaust gases produced during the roasting process are subjected to a flameless regenerative thermal oxidation for removing airborne pollutants and odorous substances, and preferably the energy released during oxidation of the exhaust air pollutants is directly provided to the process.

The roasting device according to the present disclosure for vegetable bulk material, in particular coffee beans, cacao beans and the like, comprises a roasting container in which the bulk material is roasted. This container is a roasting drum, for example. A heated gas, normally air, for roasting the bulk material is fed through the roasting container. For this purpose, the roasting container is connected with a gas heating furnace. Further, an exhaust gas purification means is connected via one or a plurality of exhaust gas lines with the roasting container. Possibly, further intermediate elements, such as a solid matter removal means, fans, and the like, are arranged between the roasting container and the exhaust gas purification means.

The exhaust gas purification means according to the present disclosure comprises an oxidation bed for oxidizing pollutants contained in the exhaust gas. For this purpose, the oxidation bed comprises a porous heat-accumulating and heat-exchanging material. Providing of an oxidation bed in the exhaust gas purification means allows a flameless regenerative thermal oxidation of the airborne pollutants and/or odorous substances to take place. For this purpose, according to the present disclosure, the exhaust gas purification means additionally comprises a heating element. The heating element can heat a central region, the middle of the bed, for example, or a middle region to a reaction temperature for oxidation purposes, and/or a self-decomposition temperature for the roasting exhaust gas-specific exhaust gas pollutants. Due to the oxidation of the exhaust gas pollutants in the oxidation bed according to the present disclosure, a smaller amount of additional energy for heating up or post-heating the oxidation bed is to be introduced into the exhaust gas, such that the costs can be considerably reduced. Further, providing of an exhaust gas purification means comprising an oxidation bed according to the present disclosure eliminates the disadvantages of a catalyst since the functional capability of the exhaust gas purification means is ensured within large ranges of pollutant concentration. In particular, at an excessive temperature the oxidation bed will not be destroyed or damaged, for example.

Preferably, the oxidation bed is arranged between two gas-permeable, in particular perforated bottoms. This allows an oxidation bed to be made up from loose individual parts since the oxidation bed is stabilized by the bottoms.

An essential feature of the present disclosure is that the exhaust gas purification means comprises a flow reversing means. This flow reversing means reverses the direction of flow in which the exhaust gases flow through the oxidation bed at appropriate intervals. This offers the advantage that during oxidizing of the pollutants in a middle region or second sub-region of the oxidation bed the heat thereby produced can be taken up by a first or a third sub-region of the oxidation bed adjacent the second or middle sub-region. When the exhaust gases flow in one direction, a first sub-region of the oxidation bed is heated, for example, since this first sub-region is arranged downstream of the middle sub-region. Upon reversal of the direction of flow, the exhaust gas to be purified first flows through the heated first sub-region and is continued to be heated. Subsequently, oxidizing of the gas in the middle or second sub-region and then heating of the third sub-region take place, which third sub-region is arranged downstream of the middle sub-region in which the oxidation takes place. Thus, by reversal of the direction of flow, the heat produced during oxidation and accumulated in a sub-region of the oxidation bed can be used for preheating the exhaust gases to the reaction temperature immediately prior to their oxidation.

The oxidation bed is a random packing, preferably made up of ceramic fillers of identical size. The fillers are made from fireproof material with heat-accumulating and heat-exchanging characteristics. Preferably, the fillers are rings comprising internal webs and wall breaks, however other material, such as Pall rings, Raschig rings, Berl saddles, and other fillers known per se from the distillation and rectification techniques can be used. The oxidation bed in the form of a packing made up of fillers is a porous layer which is heated up and then, in the operating condition, comprises a characteristic temperature profile in the middle region. The physically uniform layer can be theoretically visualized in the form of sub-layers, depending on the locally prevailing temperatures.

The flameless oxidation of the roasting exhaust gas-specific airborne pollutants takes place in the hottest region of the porous filler layer. Temperature peaks, like those occurring at the fronts of free flames, are prevented. Thus, a thermal nitrogen formation in the roasting exhaust gas is suppressed to a large extent in the flameless thermal oxidation.

The flameless oxidation of the roasting exhaust gas-specific airborne pollutants requires an oxygen content in the roasting exhaust gas of at least approximately 3%, and a reaction temperature in the filler layer of approximately 850° C.-1000° C.

When the above cited requirements regarding oxygen content and reaction temperature are met, even low concentrations of airborne pollutants in the roasting exhaust gas, which are not capable of promoting normal combustion, can be reliably oxidized and/or decomposed.

Surprisingly, it has turned out that in the case of an effective heat insulation of the exhaust gas purification means and the jacket of the oxidation bed, in continuous roasting operation at a normal concentration of airborne pollutants in the roasting exhaust gas, heating-up of the oxidation bed to the reaction temperature does not require any external energy supply.

Preferably, the flow reversing means is configured such that it comprises two valves provided in the region of an inlet opening and an outlet opening, respectively, of the exhaust gas purification means. Between the inlet opening and the outlet opening two flow channels are provided through which the exhaust gas flows in different directions depending on the valve position.

To make sure that the middle sub-region of the oxidation bed is always kept at the required temperature, this sub-region can be heated when a threshold temperature is not reached. To prevent the threshold temperature from not being reached in the middle sub-region, an additional energy supply means is provided. This additional energy supply means is in particular an indirect energy supply means where a fuel gas is injected into the exhaust gases for the purpose of heating the exhaust gases. The fuel gas injected into the exhaust gases then oxidizes in the middle region of the oxidation bed thus bringing about the desired heating of this region.

Preferably, all processes taking place in the roasting device are automatically controlled via corresponding sensors, in particular temperature sensors, which are connected with a control means.

In the method according to the present disclosure, which is preferably suitable for operating the roasting device described above, an oxidation bed arranged in an exhaust gas purification means is preheated to a reaction temperature for oxidation purposes and/or a self-decomposition temperature for the roasting exhaust gas-specific exhaust gas pollutants. Subsequently, an exhaust gas flow is fed from a roasting container to the exhaust gas purification means, wherein the exhaust gas flow is heated in a first sub-region of the oxidation bed. In the second or middle sub-region of the oxidation bed, through which the exhaust gas flow then flows, the roasting exhaust gas-specific exhaust gas pollutants are subjected to a flameless regenerative thermal oxidation. In the next step, the combustion gas heat energy produced during oxidation is released to the oxidation bed when the exhaust gas flows through a third sub-region. By changing the flow direction of the exhaust gas flow through the oxidation bed, the exhaust gas flows through a sub-region of the oxidation bed which has been preheated by oxidation, before it oxidizes in the middle or second sub-region of the oxidation bed. The purified exhaust gas is then discharged through a stack or the like to the atmosphere, for example. Likewise, a portion of the purified exhaust gas may be supplied to the air heating furnace in which the air to be fed to the roasting container is heated. This offers the advantage that the heat contained in the exhaust gas is further utilized in the roasting process.

Preferably, the middle region of the oxidation bed is kept at the reaction temperature for oxidation of roasting exhaust gas-specific exhaust gas pollutants. For this purpose, it may be necessary to heat the middle or second region of the oxidation layer as soon as a minimum desired value of the temperature is not reached. For this purpose, this region can be indirectly heated by mixing fuel gas into the exhaust gas flow.

Due to the flameless thermal oxidation according to the present disclosure in the second sub-region of the oxidation bed and the subsequent regenerative heat exchange, the discharge temperature of the roasting exhaust gas is by approximately 40-60°, preferably by approximately 50°, higher than the oxidation bed inlet temperature.

Preferably, the keeping of the temperature of the middle region of the oxidation bed at the reaction temperature is automatically controlled and monitored in particular with the aid of a plurality of temperature sensors.

An essential advantage of the roasting device according to the present disclosure and the roasting method according to the present disclosure is that the roasting process and the exhaust gas purification process are essentially decoupled from each other, and the disadvantages of the thermal and catalytic roasting exhaust gas combustion are avoided.

It has turned out to be particularly appropriate to supply odorous substance-laden exhaust air flows from other processing stages (e.g. roasted-coffee cooler, pitting stage, pneumatic conveyors and other diffuse exhaust air sources) to the device for emission reduction purposes. The overall emission level of the roasting plant and the roasted-product processing plant can be further reduced in this manner.

### BRIEF DESCRIPTION OF THE DRAWINGS

Several embodiments of the present disclosure will now be described in greater detail with reference to the drawings in which:

FIG. 1 shows a schematic block diagram of a roasting assembly according to the present disclosure for vegetable bulk material, in particular coffee beans, including a regenerative exhaust gas purification plant;

FIG. 2 shows a variant of the assembly illustrated in FIG. 1, comprising a return line for a partial flow of the roasting exhaust gases to the air heating furnace provided for roasting supply air;

FIG. 3 shows a variant of the assembly illustrated in FIG. 1, showing the return of a partial flow of thermally purified exhaust air from the regenerative exhaust gas purification plant to the air heating furnace provided for roasting supply air;

FIG. 4 shows a schematic fragmentary section of the regenerative thermal exhaust gas purification plant comprising an oxidation bed through which exhaust gas flows from bottom to top; and

FIG. 5 shows a schematic fragmentary section of the regenerative thermal exhaust gas purification plant comprising an oxidation bed through which exhaust gas flows from top to bottom.

### DETAILED DESCRIPTION OF THE PREFERRED EMBODIMENT

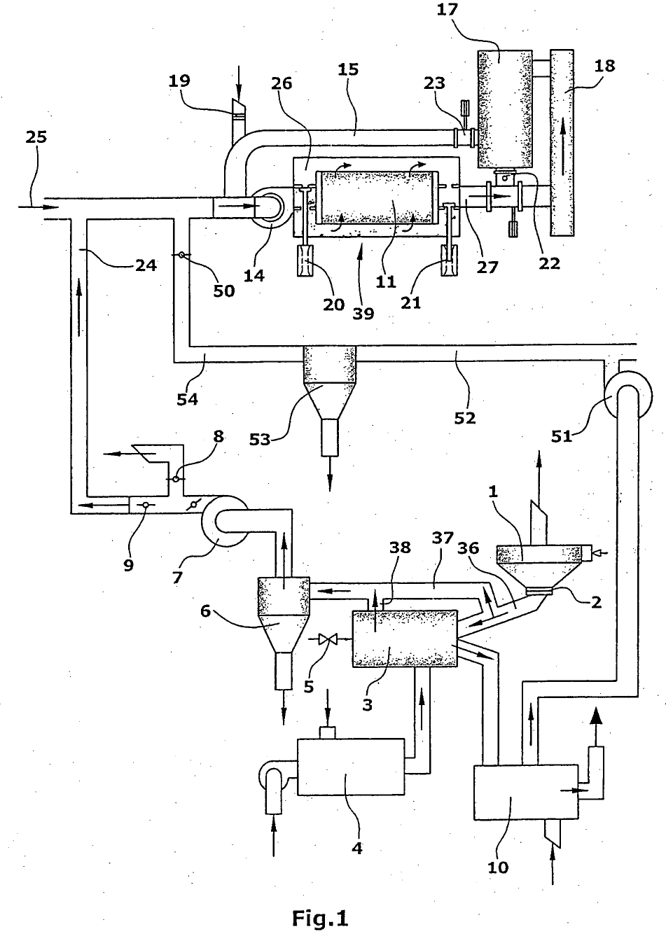

The coffee bean roasting plant schematically shown in FIG. 1 comprises a roaster having a roasting drum or roasting container 3 to which the coffee beans to be roasted are supplied from the machine hopper 1 as soon as the automatically driven filling flap 2 opens. The coffee beans roasted in the roasting drum 3 in a hot air flow coming from the gas or air heating furnace 4 are supplied to a cooler 10. In the cooler 10, the coffee beans are cooled in a cooling air flow and subsequently fed to a pitting plant not shown.

A connecting pipe 36 between the machine hopper 1 and the roasting drum 3 comprises a branch 37 which is connected with an exhaust gas outlet 38 of the roasting drum 3 and, in connection with the roasting drum 3, extends to a roasting cyclone 6.

The raw coffee sporadically travels by gravity through the connecting pipe 36 and into the roasting drum 3. At the top of the connecting pipe 36 a branch 37 is connected. The roasting exhaust gases from the roasting drum 3 are drawn off through the branch 37. At the exhaust gas outlet 38 an exhaust gas flow meets the roasting exhaust gas flow, the former having indirectly heated the roasting drum 3 from outside. The roasting exhaust gas flow from the branch 37 and the exhaust gas flow from the exhaust gas outlet 38 are treated as a single exhaust gas flow and liberated from pellicles and dust in the roasting cyclone 6.

It shall be understood that other roaster types and roasting plants operating both in batches and continuously may also be used; further, plants for roasting other vegetable bulk material, for example cacao, nuts or cereals, can be used.

Following the automatically controlled transmission of the thermal energy of the hot air from the air heating furnace 4 to the products to be roasted, the exhaust air from the roasting drum 3 loaded with roasting exhaust gases is drawn by the roasting fan 7 through the roasting cyclone 6. In the roasting cyclone 6, pellicles and dust are separated by centrifugal forces.

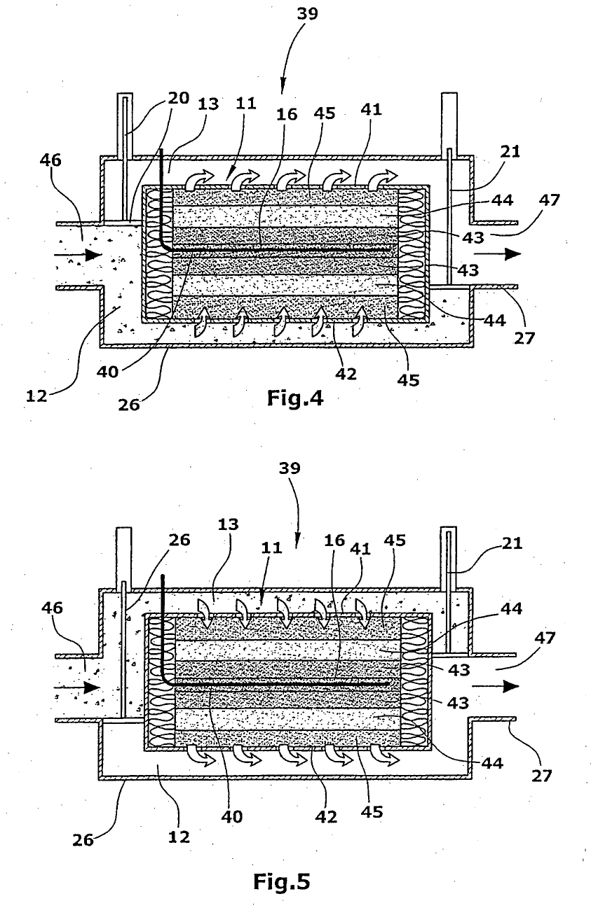

Upon initial operation of the roasting plant, an oxidation bed 11 arranged in an exhaust gas purification means 39 is heated up in a second region or the middle 16 of the bed by an electrical heating element 40 (FIGS. 4 and 5) to an operating temperature ranging between approximately 850 and 1000° C. The oxidation bed 11 is made up of a porous layer of ceramic fillers arranged between bottoms 41,42 in the center of an effectively heat-insulated container 26.

The oxidation bed 11 arranged in the exhaust gas purification means 39 and defined by the two bottoms 41,42 may be theoretically divided into layers 16, 43, 44 and 45 based on the local temperature ranges. Here, the middle layer 16 defines the second or middle sub-region of the oxidation bed. In this sub-region the oxidation takes place. Possibly, the middle sub-region extends into the layer 43 adjacent to the layer 16. Depending on the direction of flow, the layers 44,45 define the first or the third sub-region of the oxidation bed 11. These regions may also extend into the boundary layer 43.

The roasting fan 7 supplies the mechanically purified roasting exhaust gas through the conduit 24 to the roasting exhaust air fan 14. The fan 14 feeds the respective volume flow of roasting exhaust air in a frequency-controlled manner through the oxidation bed 11 which is automatically kept at the operating temperature. The oxidation bed 11 serves for flameless oxidizing of the odorous substances and airborne pollutants of the roasting exhaust gas, and as a heat accumulator for the reaction heat. The energy released during oxidation of the roasting exhaust gas-specific airborne pollutants substantially contributes to maintaining the process temperature in the oxidation bed 11.

It is unavoidable that heat losses occur in the oxidation bed. To ensure that the oxidation zone remains in the middle 16 of the bed and to attain a uniform oxidation, the direction of flow of the roasting exhaust gases through the oxidation bed 11 is periodically changed. In one phase (FIG. 4) the disk valve 20 arranged in the region of an inlet opening 46 clears the way for the roasting exhaust air to travel to the lower air distribution chamber 12 or lower flow channel 12. A disk valve 21 arranged in the region of an outlet opening 47 closes the lower air distribution chamber 12 at the container outlet 27. The roasting exhaust gases to be purified flow from bottom to top through the oxidation bed 11, as shown in FIG. 4. The exhaust gases first flow through the first sub-region, i.e. the layers 45,44, thereby being heated, before they travel to the middle sub-region 16 after having flown through the intermediate layer 43, in which middle sub-region 16 the exhaust gases are oxidized. Then the oxidized exhaust gases flow through the third sub-region, i.e. the upper layers 43, 44 and 45 shown in FIG. 4, thereby heating said layers. The purified roasting exhaust air is fed via the upper air distribution chamber 13 to the container outlet 27.

In the other phase, the disk valves 20 and 21 are changed over, and the roasting exhaust gas to be purified then flows from the upper air distribution chamber 13 from top to bottom through the oxidation bed 11, as shown in FIG. 5. In the illustrated embodiment, the disk valves 20,21 thus define the flow reversing means.

Depending on the respective direction of flow, the roasting exhaust gases to be purified, as from entry of the roasting exhaust gases into the oxidation bed 11, are heated up in the respective first half of the oxidation bed. Following the subsequent oxidation in the middle 16 of the bed, in the second half of the oxidation bed 11 the thermally purified roasting exhaust gases then release the enthalpy to the ceramic fillers. The thermal energy released during oxidation is accumulated at a high rate of energy utilization by the ceramic material of the oxidation bed 11 for the purpose of heating up the roasting exhaust air to the oxidation temperature after reversal of the direction of flow. The purified roasting exhaust air is discharged via a stack 18 to the atmosphere.

During the changeover interval of the disk valves 20 and 21, a comparably small amount of unpurified exhaust air escapes through the container outlet 27. If this unpurified roasting exhaust gas does not cause the time average of the emissions to increase in an inadmissible manner, the exhaust air can be discharged via the stack 18 to the atmosphere.

For the purpose of further reducing the emission, the plant may additionally be extended by an exhaust air storage tank 17 and installations for appropriately guiding the exhaust air. In this case, the unpurified roasting exhaust gas is guided from the container outlet 27, through the open isolating damper 22 and into the exhaust air storage tank 17 during the changeover interval of the disk valves 20 and 21. When the changeover operation is terminated, the roasting exhaust gas is returned from the exhaust gas storage tank 17 through the open isolating damper 23 and a conduit 15 arranged upstream of the roasting exhaust air fan 14 to the purifying process in the period up to the next changeover of the disk valves 20 and 21. During this phase, purified exhaust air from the stack 18 is supplied from above into the exhaust air storage tank 17.

As soon as the concentration of the hydrocarbons and carbon monoxide compounds in the roasting exhaust air to be purified decreases to such an extent that during oxidation of said roasting exhaust air the operating temperature in the oxidation bed drops, an automatic temperature control ensures that via the gas lance 25, which serves as an energy supply means, fuel gas, e.g. natural gas, is injected into the intake line of the roasting exhaust gas fan 14. Connection and disconnection of the gas supply are performed automatically via the signals fed from thermocouples to the storage-programmable control. The automatic system is active even during stand-by operation, e.g. when the air heating furnace 4 is out of operation or the roasting operation is interrupted.

Together with the roasting plant, the plant for flameless regenerative thermal roasting exhaust gas purification is automatically controlled and monitored.

If required, fresh air may be dosed into the exhaust air flow, which is fed by the roasting exhaust air fan 14, by controlled opening of the fresh air flap 19.

Via a flap 50 odorous substance-laden exhaust air from the cooler 10 may additionally be supplied to the exhaust gas purification means 39 for the purpose of purifying said exhaust air together with the roasting exhaust gas flow in the oxidation bed 11. Supply of the cooler exhaust air via a cooler exhaust air fan 51, a cooler exhaust air conduit 52, a cooler exhaust air cyclone 53 and a cooler exhaust air conduit 54 may take place in batch operation by a corresponding control, or sporadically only in the initial stage of the cooling process.

In front of the roasting exhaust air fan 14, as seen in downstream direction, further exhaust air flows may additionally be supplied for the purpose of purifying them together with the roasting exhaust gases in the oxidation bed 11. For this purpose, conduits, flaps and fans, which are not shown, are connected.

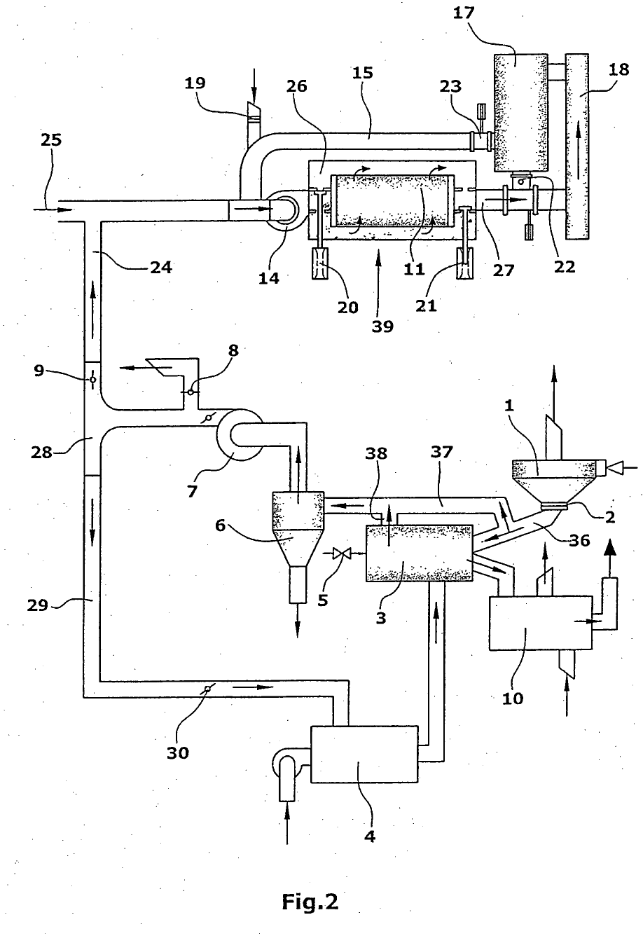

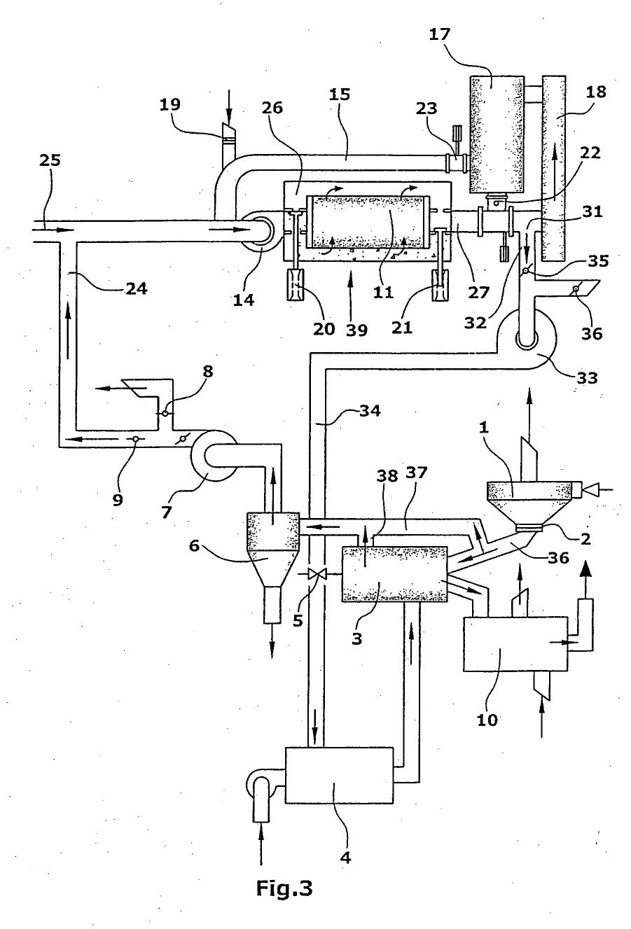

The embodiments described below and shown in FIG. 2 and FIG. 3 apply the principle explained with reference to FIG. 1. Components serving the same purpose are designated by the reference numerals of FIG. 1. For illustration purposes, reference is made to the description of FIG. 1.

FIG. 2 shows a variant of the plant illustrated in FIG. 1, which primarily differs in that the roasting exhaust gas flow is divided into two partial flows by a flow divider 28. The main flow of the roasting exhaust gases is returned via a re-circulation line 29 and a control damper 30 to the air heating furnace 4 and is reheated there to the required roasting supply air temperature. The other partial flow is the excess volume from the roasting air circulation; it has a comparably higher concentration of odorous substances and pollutants and is supplied via the roasting exhaust gas conduit 24 and the roasting exhaust air fan 14 to the container 26. The plant for flameless regenerative thermal oxidation operates as described with reference to FIG. 1.

Due to the comparably higher concentration of hydrocarbons and carbon monoxide compounds in the excess volume from the roasting exhaust air circulation, externally supplied fuel gas can be saved, i.e. comparably less gas is to be injected via the gas lance 25 during the roasting operation.

FIG. 3 shows a variant of the plant illustrated in FIG. 1, which primarily differs in that a partial flow of thermally purified exhaust air from the container outlet 27 is returned to the air heating furnace 4 where it is heated up to the required heat level of the roasting supply air. The thermally purified exhaust air is thus at least partly used as roasting supply air. In this manner, the thermal energy of the purified exhaust air is utilized to the largest extent possible.

Between the container outlet 27 and the stack 18 a flow divider 31 for two partial flows is arranged. The flow divider 31 guides one partial flow of the purified exhaust air through the stack 18 to the atmosphere. The second partial flow is guided through a conduit 32 to a fan 33. The fan 33 feeds the exhaust gas partial flow through the recirculation line 34 and to the air heating furnace 4. The automatic timed regulation of the volume flow is performed in a manner known per se with the aid of a frequency-controlled drive motor at the fan 33 or with the aid of control dampers 35,36 in the conduits.

Besides the high rate of heat utilization for emission reduction and the roasting process, it is advantageous that the products to be roasted are treated in the roasting drum 3 with roasting supply air with a comparably low concentration of odorous substances and pollutants. Thus, flavor deteriorations of the products to be roasted are prevented.

What is claimed is:

1. A roasting device for vegetable bulk material comprising:
a roasting container for roasting the vegetable bulk material,
a gas heating furnace connected with the roasting container for supplying heated gases into the roasting container, and
an exhaust gas purifier connected via an exhaust gas line with the roasting container,
wherein the exhaust gas purifier comprises an oxidation bed made up of porous heat-accumulating and heat-exchanging material for exhaust gas oxidation,
a heating element for heating a sub-region of the oxidation bed to a reaction temperature for oxidation purposes and/or a self-decomposition temperature for roasting exhaust gas-specific exhaust gas pollutants, and
a flow reverser for reversing the direction of flow of the exhaust gases through the oxidation bed.

2. The roasting device according to claim 1, wherein in that the oxidation bed is arranged between two gas-permeable bottoms.

3. The roasting device according to claim 1, wherein the oxidation bed is of single-layer configuration.

4. The roasting device according to claim 1, wherein the exhaust gas purifier comprises an inlet opening and an outlet opening between which two flow channels are arranged, wherein the inlet opening and the outlet opening each have associated therewith a valve for connection with a respective one of the two flow channels.

5. The roasting device according to claim 1, further comprising an energy supply arranged upstream of the exhaust gas purifier for supplying the exhaust gases with energy.

6. The roasting device according to claim 1, further comprising a supply arranged upstream of the exhaust gas purifier for supplying fresh air and/or exhaust air loaded with odorous substances from the other plant sections.

7. The roasting device according to claim 1, further comprising a flow divider arranged upstream of the exhaust gas purifier for the roasting exhaust air flow from the roasting container, and a conduit for returning a partial flow to the circulation to the gas heating furnace.

8. The roasting device according to claim 1, further comprising a flow divider arranged downstream of the exhaust gas purification means for thermally purified exhaust gas is provided, said flow divider comprising a conduit for returning a partial flow of the exhaust gas to the gas heating furnace.

9. The roasting device according to claim 8, wherein in the conduit an exhaust gas damper and a fresh air damper are provided which are, in combination, adapted to be opened and closed in opposite directions.

10. The roasting device according to claim 1, wherein an exhaust air storage tank for receiving an exhaust air volume is provided, wherein the exhaust air storage tank is connected with the exhaust air cleaning means for receiving unpurified exhaust air from the exhaust gas purifier during changeover of the flow reverser and subsequently returning said unpurified exhaust air to the exhaust gas purifier.

11. A method for operating a roasting device for vegetable bulk material, the method comprising the following:
preheating of an oxidation bed arranged in an exhaust gas purifier,
supplying of an exhaust gas flow to the exhaust gas purifier, wherein the exhaust gas flow is heated in a first sub-region of the oxidation bed,
flameless regenerative thermal oxidizing of the roasting exhaust gas-specific exhaust gas pollutants in a second sub-region of the oxidation bed,
transmitting of the heat energy of the combustion gas of the thermally purified roasting exhaust air to the heat-accumulating material of the oxidation bed when the exhaust air flows through a third sub-region of the oxidation bed,
periodical changing of the direction of flow of the roasting exhaust gases through the oxidation bed, wherein a regenerative countercurrent heat exchange is maintained, and
transferring of the thermally purified roasting exhaust gases for returning them to the gas heating furnace and/or the atmosphere.

12. The method according to claim 11, wherein the second sub-region of the oxidation bed is kept at a reaction temperature for oxidation of roasting exhaust gas-specific exhaust gas pollutants.

13. The method according to claim 11, wherein the temperature of the second sub-region of the oxidation bed is increased by mixing fuel gases into the exhaust gas flow when said temperature decreases below a given minimum desired value.

14. The method according to claim 11, wherein the discharge temperature of the roasting exhaust gas is by approximately 50° C. higher than the oxidation bed inlet temperature.

15. The method according to claim 11, wherein preheating of the second sub-region of the oxidation bed is automatically controlled and monitored, and preferably only takes place prior to startup of the roasting plant.

16. The method according to claim 11, wherein, prior to introduction into the exhaust gas purification means comprising the oxidation bed, fresh air and/or cooler exhaust air and/or odorous substance-loaded exhaust air drawn off from other plant sections is admixed.

17. The method according to claim 11, wherein the roasting exhaust air flow to be purified is a partial flow made up of the excess volume from a roasting air circulation, and wherein the second partial flow of the roasting exhaust air is returned to the air heating furnace and reheated there.

18. The method according to claim 11, wherein during each phase of changing the direction of flow through the oxidation bed the partial volume of unpurified exhaust gas from the exhaust gas purifier is introduced into an exhaust air storage tank for the purpose of returning said unpurified exhaust gas from the exhaust gas storage tank to the roasting exhaust air flow to be purified after termination of the changeover phase.

19. The method according to claim 11, wherein an automatically operating temperature control monitors the operating temperature and the standby temperature in the oxidation bed, and introduces fuel gas via a gas lance into the exhaust air flow to the oxidation bed if a desired value is not reached in the middle of the bed.

20. The method according to claim 11, wherein the flameless regenerative thermal oxidation of the roasting exhaust gas-specific airborne pollutants in the second sub-region of the oxidation bed takes place at a temperature in the range from approximately 850° C. to approximately 1000° C.
